(19) United States
(12) Patent Application Publication
(10) Pub. No.: US 2022/0221088 A1
(43) Pub. Date: Jul. 14, 2022

(54) FLUID LINE HAVING A WAVE FORM PORTION

(71) Applicant: NORMA Germany GmbH, Maintal (DE)

(72) Inventors: Daniel Kintea, Maintal (DE); Gerrit von Breitenbach, Maintal (DE); Stephan Senftleben, Maintal (DE); Christian Sakowski, Maintal (DE); Sven Schwäblein, Maintal (DE); David Schoumacher, Briey (FR)

(21) Appl. No.: 17/606,573

(22) PCT Filed: Apr. 20, 2020
(86) PCT No.: PCT/EP2020/061021

§ 371 Date: Oct. 26, 2021

(30) Foreign Application Priority Data
Apr. 26, 2019 (DE) 10 2019 110 849.7

(51) Int. Cl. F16L 11/15

(52) U.S. Cl. CPC F16L 11/15

(57) ABSTRACT

A fluid line having a wave form portion is furnished. The wave form portion extends at least at a minimum distance along a longitudinal axis of the fluid line. The wave form portion has a wave peak element (18), which itself has, along a peripheral direction extending around the longitudinal axis of the fluid line, a varying distance from the longitudinal axis, the distance including a distance curve in the peripheral direction, the distance curve providing a non-circular contour. A fluid line is thus provided having a wave form portion, which fluid line reduces the pressure drop at the wave form portion.

The invention relates to a fluid line having a wave form portion according to the preamble of claim 1.

In the case of applications in the automotive industry, e.g. for cooling water or for thermal management of electric vehicles, the pressure loss of the system is critical and must be kept as low as possible. At the same time, the weight should be reduced and the lines should be formed flexibly in order to balance out relative movements between the connecting points and enable easy mounting. Rubber hoses are frequently used in certain conditions, these offering high flexibility and low pressure losses. They, therefore, tend to be heavy and expensive.

Extruded plastic tubes are significantly lighter and lower cost. They are typically either smooth, corrugated or partially corrugated. Smooth tubes have low pressure losses, but are relatively stiff, while corrugated hoses have a flexibility which is comparable with that of rubber. However, the gain in flexibility is at the cost of significantly increased pressure losses. The pressure losses can be encouraged by the wave form since a fluid flowing via a wave form cannot follow the waves. This leads to increased friction and turbulence of the fluid flow on the wall so that the fluid flow detaches from the wall. The detachment from the wall facilitates the generation of vortices which bring about a reduction in flow speed.

In order to reduce pressure losses, it is known to use hoses which have a wave form only in curve regions, i.e. only in the regions in which flexibility is required. Despite reduced pressure loss in comparison with corrugated hoses, the pressure loss of these hoses is much greater than in the case of rubber hoses.

It can therefore be regarded as an object of the invention to provide a fluid line having a wave form portion which further reduces a drop in pressure at the wave form portion.

The main features of the invention are indicated in the characterizing part of claim 1. Configurations are the subject matter of claims 2 to 13.

In the case of a fluid line having a wave form portion, wherein the wave form portion extends at a minimum distance along a longitudinal axis of the fluid line, it is provided according to the invention that the wave form portion has a wave crest element which has a varying distance to the longitudinal axis along a circumferential direction extending around the longitudinal axis of the fluid line, wherein the distance comprises a distance profile in the circumferential direction, wherein the distance profile provides a non-circular contour.

With the invention, there is used a wave form portion having wave crest elements for the generation of a curve in the fluid line, where an optimized curve form of the fluid line is provided as a result of the varying distance of the wave crest element to the longitudinal axis along the circumferential direction around the longitudinal axis. The varying distance of the wave crest element in the circumferential direction brings about that the flexibility of the wave form portion varies along the circumferential direction. A circumferential position of the wave crest element which has a large distance to the longitudinal axis of the fluid line brings about high flexibility at this position. A circumferential position of the wave crest element with a small distance to the longitudinal axis brings about low flexibility at this position. The flexibility of the wave form portion can thus be selected locally by means of the distance to the longitudinal axis so that, when generating a curve in the fluid line, optimized flexibility of the wave form portion is provided at the wave form portion for each angle position along the circumferential direction around the longitudinal axis. Higher flexibility can thus be provided, for example, at the circumferential positions of the wave crest element which are provided to form the outer radius of the curve than at the circumferential positions of the wave crest element which form the inner radius. As a result of the locally optimized flexibility of the wave form portion, an optimized curve form can be provided which provides on the inner radius of the curve inside the fluid line a surface with a minimal wave form, i.e. waves with a very small amplitude, or a smooth surface on which the generation of vortices in the flow is reduced. This brings about a reduction or avoidance of a drop in pressure at the curve of the fluid line generated at the wave form portion.

The distance of the wave crest element can change continuously along the circumferential direction.

A continuous change in flexibility in which the distance is changed continuously along the circumferential direction can thus be provided e.g. between the two circumferential positions which should form the outer and inner radius of a curve on the wave form portion. The flexibility of the wave form portion can thus be adapted evenly more expediently to the curve to be produced of the fluid line so that a drop in pressure is further reduced.

In this case, the distance in the circumferential direction can change according to a sine function or according to a square of a sine function.

The wave crest element can furthermore extend in the circumferential direction only around a partial circumference of the wave form portion.

By means of the partial extension of the wave crest element around the circumference, the increased flexibility can be provided by means of the wave form only at the positions at which increased flexibility is required for stretching of the material. No increased flexibility is e.g. regularly required at the provided inner radius of a curve of the fluid line so that the wave form can be dispensed with at these positions, as a result of which a further reduction in the drop in pressure is brought about.

The fluid line can thus have a wave-free wall portion which has along the longitudinal axis a smooth surface, wherein the wave form portion in the circumferential direction comprises a first end region and a second end region, wherein the wave-free wall portion extends between the first and the second end region.

By providing the wave-free wall portion, it can be ensured that a smooth wall surface is present in the inner space of the fluid line at the provided inner radius of a curve of the fluid line. Increased friction in the fluid flow on the inner radius of the curve is thus counteracted. In combination with the increased flexibility of the wave form portion at the wave crest elements, the wave-free wall portion is subject, if at all, only to a small change in length along the longitudinal axis. Moreover, the wave-free wall portion is thus not compressed so that the smooth surface of the wave-free wall portion does not have any humps which can regularly be brought about by the compression of materials. This contributes to a further reduction in the drop in pressure in the fluid flow.

The wave-free wall portion can be arranged at the minimum distance to the longitudinal axis.

The wave-free wall portion thus has the same distance to the longitudinal axis as the further portions of the fluid line which adjoin the wave form portion.

In a further example, the wave crest element can have a maximum distance to the longitudinal axis, wherein a position of the maximum distance in the circumferential direction is arranged diametrically opposite a position of the wave form portion which has the minimum distance to the longitudinal axis.

Thus, a circumferential position with maximum flexibility and a circumferential position with minimum flexibility lie diametrically opposite one another in the circumferential direction. When generating a curve in the fluid line, as a result of their locally higher flexibility, the circumferential position with the maximum distance to the longitudinal axis is therefore primarily deformed and the circumferential position with the minimum distance to the longitudinal axis is deformed to a small degree or not at all. The distance of the wave-free wall portion can be constant to the longitudinal axis in the circumferential direction. This brings about an optimally formed wall surface on the inner radius of the curve which further reduces vortices and thus a drop in pressure.

The wave-free wall portion can furthermore have a neutral axis of the fluid line.

No change in length is thus brought about in the wave-free wall portion at the position of the neutral axis of the fluid line when generating a curve. This further brings about that the entire wave-free wall portion is subject to only a small change in length in comparison with the range which the wave crest element has when generating a curve.

The wave-free wall portion can, in the circumferential direction, cover an angle in the range between 0° and 180°, preferably between 0° and 120°, further preferably between 0° and 80°.

The fluid line can furthermore have at least one wave-free line portion which extends along the longitudinal axis away from the wave form portion.

The wave form portion can thus be arranged between wave-free line portions in a targeted manner on a provided curve.

The wave form portion can furthermore have a plurality of wave crest elements, wherein in each case a wave trough element which is arranged at the minimum distance to the longitudinal axis is arranged between in each case two wave crest elements.

The number of wave crest elements in the wave form portion can be adapted to the length of extent or the bending angle of the provided curve. The larger the bending angle of the provided curve, the more wave crest elements can be used.

The fluid line can have a curve in which the wave form portion is arranged.

The wave crest element can furthermore be arranged on an outer radius of the curve.

The wave form portion can have the minimum distance on an inner radius of the curve across its entire extent along the longitudinal axis.

Further features, details and advantages of the invention arise from the wording of the claims and from the following description of exemplary embodiments on the basis of the drawings. In the drawings:

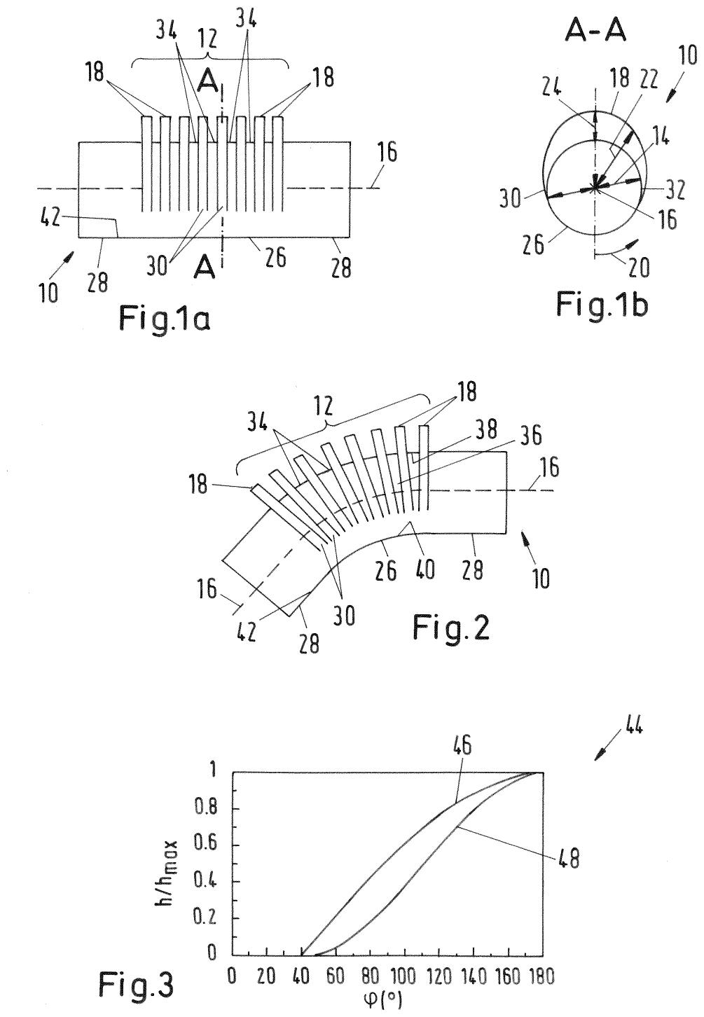

FIGS. 1a, b show sectional drawings of a schematic representation of a fluid line having a wave form portion;

FIG. 2 shows a schematic representation of a fluid line having a bent wave form portion; and

FIG. 3 shows a diagram with exemplary profiles of the varying distance along the circumferential direction.

A fluid line is represented schematically in FIG. 1a and is referred to in its entirety by the reference number 10.

FIG. 1a shows schematic representation of fluid line 10 in a side view. Fluid line 10 extends in the horizontal direction along longitudinal axis 16 and can be formed from an extruded plastic material. Fluid line 10 further comprises a wave form portion 12 which extends at a minimum distance 14 to longitudinal axis 16 along longitudinal axis 16 of fluid line 10. Wave form portion 12 is arranged between two line portions 28 which do not have a wave form. On the contrary, line portions 28 have a smooth wall. In this case, wave form portion 12 is arranged at a position at which a curve should be produced in fluid line 10.

Wave form portion 12 has at least partially a wave-shaped wall portion which has at least one wave crest element 18 which extends between a maximum distance 24 to longitudinal axis 16 and minimum distance 14 to longitudinal axis 16. Wave form portion 12 comprises according to figure la a plurality of wave crest elements 18 which are separated from one another by wave trough elements 34. A wave trough element 34 is arranged at minimum distance 14 to longitudinal axis 16. The number of wave crest elements 18 in wave form portion 12 can be adapted to the length of extent or the bending angle of the provided curve. The larger the bending angle of the provided curve, the more wave crest elements 18 can be used.

The at least one wave crest element 18 extends according to FIG. 1b in a circumferential direction 20, extending around longitudinal axis 16, of fluid line 10. FIG. 1b shows a view of fluid line 10 along longitudinal axis 16. The representation of fluid line 10 corresponds in this case to a section along line A-A from FIG. 1a, wherein longitudinal axis 16 is arranged orthogonally to the sectional surface.

Along circumferential direction 20, wave crest element 18 has a varying distance 22 to longitudinal axis 16. I.e. if wave crest element 18 is followed along circumferential direction 20, distance 22 of wave crest element 18 to longitudinal axis 16 changes. Various angle positions of the wave crest element 18 along circumferential direction 20, which can also be referred to here as circumferential positions, have different distances 22 to longitudinal axis 16.

This brings about that wave crest element 18 is formed to have varying flexibility at the various circumferential positions. The local flexibility of wave crest element 18 can thus be adjusted so that it corresponds to the required local flexibility for generating a curve in fluid line 10. Regions which are supposed to form an outer radius of the curve have increased flexibility, in which distance 22 are increased in these regions up to maximum distance 24. The remaining regions in which an inner radius of the curve should be formed have smaller or no increased distances 22 at their circumferential positions.

In this case, wave crest element 18 comprises a first circumferential position at which wave crest element 18 has maximum distance 24 to longitudinal axis 16. The first circumferential position is diametrically opposite a further circumferential position at which wave crest element 18 has minimum distance 14 to longitudinal axis 16.

Wave crest element 18 furthermore extends in circumferential direction 20 only around a partial circumference of wave form portion 12. In this case, wave crest element 18 comprises a first end region 30 and a second end region 32. At both end regions 30, 32 of wave crest element 18, varying distance 22 is reduced from maximum distance 24 proceeding in circumferential direction 20 until it corresponds to minimum distance 14 at a circumferential position outside wave crest element 18. Varying distance 22 consequently increases between the two end regions 30, 32 continuously up to maximum distance 24. A circumferential position with a maximum flexibility and a circumferential position with a minimum flexibility lie diametrically opposite one another in circumferential direction 20. When a curve 36 is created in fluid line 10, the flexibility of the circumferential position with maximum distance 24 to longitudinal axis 16 is therefore primarily deformed and the circumferential position with minimum distance 14 to longitudinal axis 16 is deformed to a small degree or not at all.

The two end regions 30, 32 are connected to one another in circumferential direction 20 outside wave crest element 18 in wave form portion 12 by a wave-free wall portion 26, which can also be referred to as a smooth region. Wave-free wall portion 26 has in this case a smooth wall which has no waves in a direction along longitudinal axis 16 and in circumferential direction 20, rather is formed to be smooth. Moreover, wave-free wall portion 26 is arranged at minimum distance 14 from longitudinal axis 16. The distance of wave-free wall portion 26 to longitudinal axis 16 can furthermore be constant over its entire surface.

This brings about that, in order to produce a curve in fluid line 10 after a bending process of the wave form portion 12, free wall portion 26 provides a non-corrugated edge surface for the fluid flow arranged in fluid line 10 on an inner radius of the curve. A fluid flow will thus only have a low degree of friction and turbulence on the inner radius of the curve. This avoids an interruption in the fluid flow from wave-free wall portion 26 so that vortices and thus a drop in pressure in fluid line 10 are reduced or avoided.

FIG. 2 shows fluid line 10, in the case of which wave form portion 12 is bent and provides a curve 36 in fluid line 10. Curve 36 has in this case an outer radius 38 and an inner radius 40. Wave crest elements 18 with wave trough elements 34 therebetween extend in circumferential direction 20 over the region of curve 36 which is arranged on outer radius 38. The plurality of wave crest elements 18 in interaction with wave trough elements 34 are arranged along outer radius 38 and form along longitudinal axis 16 the wave form of wave form portion 12. The region around inner radius 40 of curve 36 is free from wave crest elements 18.

Greater flexibility of the material of fluid line 10 by means of wave crest elements 18 is thus provided on outer radius 38 of curve 36 than on inner radius 40 of curve 36. This brings about that the material on outer radius 38 of curve 36 can be stretched along longitudinal axis 16 without a large degree of effort. By varying distance 22 in circumferential direction 20, the flexibility of the material which is provided by wave crest elements 18 is reduced up to end regions 30, 32 of wave crest elements 18.

As a result of this, the local stretching of wave form portion 12 is likewise reduced at these positions. I.e., along circumferential direction 20, the material of fluid line 10 is subject to a varying degree of stretching depending on distance 22 of wave crest element 18. No stretching of the material is performed any more at inner radius 40 of curve 36. Neutral axis 42 of fluid line 10 is arranged at this position.

Wave-free wall portion 26 is neither compressed nor stretched at neutral axis 42. A slight stretching of wave-free wall portion 26 which is facilitated with the start of end regions 30, 32 as a result of the increase in the flexibility of wave form portion 12 is performed in the direction of wave crest elements 18.

As a result of this, vortices in a fluid flow which flows through fluid line 10 and through curve 36 are avoided. As a result of the avoidance of vortices in the fluid flow, a drop in pressure in the fluid flow is furthermore reduced or even avoided.

FIG. 3 shows a diagram 44 that plots the difference of the local distance of a circumferential position of a wave crest element 18 to minimum distance 14 against the circumferential angle in circumferential direction 20. The difference is standardized to the maximum difference, i.e. the difference between maximum distance 24 and minimum distance 14. The circumferential angle is represented here from 0° to 180°, wherein it is assumed that, in the case of a circumferential angle of 180°, the circumferential position of wave crest element 18 is arranged with maximum distance 24. The distance profile in circumferential direction 20 provides a non-circular contour. Starting from the 0° position, diagram 44 shows the distance profile in circumferential direction 20 and in the opposite direction to circumferential direction 20. I.e. that diagram 44 only shows half a rotation around the longitudinal axis in circumferential direction 20 or counter to circumferential direction 20.

A first distance profile 46 of wave crest element 18 in circumferential direction 20 is sinusoidal in this case, wherein the minimum distance is present between an angle range between 0° and 40° and the sinusoidal profile begins from the angle position 40°. I.e. wave-free wall portion 26 or smooth region covers, in circumferential direction 20, an angle between 0° and 180°, preferably between 0° and 120°, further preferably between 0° and 80°. The maximum of first distance profile 46 is arranged in the case of angle position 180°.

A second distance profile 48 has a form which corresponds to the square of a sine. Second distance profile 48 initially rises to a lesser extent than first distance profile 46. In the case of larger circumferential angles, the gradient of second distance profile 48 is, however, larger than the gradient of first distance profile 46 so that second distance profile 48 at the 180° position also has maximum distance 24.

The two distance profiles 46,48 merely show examples of varying distance 22 along circumferential direction 20 of a wave crest element 18. Other profiles of the distance are consequently not ruled out and can likewise be applied. In particular, in circumferential direction 20, the angle range of wave-free wall portion 26 or of wave crest element 18 can be formed to be larger or smaller than explained in this exemplary embodiment.

The invention is not restricted to one of the embodiments described above, but rather can be modified in various ways.

All of the features and advantages which proceed from the claims, the description and the drawing, including constructive details, spatial arrangements and method steps, can be essential to the invention both on their own and in the wide range of combinations.

### LIST OF REFERENCE NUMBERS

10 Fluid line

12 Wave form portion

14 Minimum distance

16 Longitudinal axis

18 Wave crest element

20 Circumferential direction

22 Varying distance

24 Maximum distance

26 Wall portion

28 Line portion

30 First end region

32 Second end region

34 Wave trough element

36 Curve

38 Outer radius

40 Inner radius

42 Neutral axis

44 Distance/angle diagram

46 First distance profile

48 Second distance profile

1. A fluid line having a wave form portion, wherein the wave form portion extends at least at a minimum distance along a longitudinal axis of the fluid line, wherein the wave form portion has a wave crest element which has a varying distance to the longitudinal axis along a circumferential direction extending around the longitudinal axis of the fluid line, wherein the distance comprises a distance profile in the circumferential direction, wherein the distance profile provides a non-circular contour.

2. The fluid line as claimed in claim 1, wherein the distance in the circumferential direction changes according to a sine function.

3. The fluid line as claimed in claim 1, wherein the wave crest element extends in the circumferential direction only around a partial circumference of the wave form portion.

4. The fluid line as claimed in claim 1, wherein the wave crest element has a maximum distance to the longitudinal axis, wherein a position of the maximum distance in the circumferential direction is arranged diametrically opposite a position of the wave form portion which has the minimum distance to the longitudinal axis.

5. The fluid line as claimed in claim 1, wherein the fluid line has a wave-free wall portion which has a smooth surface along the longitudinal axis, wherein the wave form portion in the circumferential direction comprises a first end region and a second end region, wherein the wave-free wall portion extends between the first and the second end region.

6. The fluid line as claimed in claim 5, wherein the wave-free wall portion is arranged at the minimum distance to the longitudinal axis.

7. The fluid line as claimed in claim 5, wherein the distance of the wave-free wall portion to the longitudinal axis in the circumferential direction is constant.

8. The fluid line as claimed in claim 5, wherein the wave-free wall portion has a neutral axis of the fluid line.

9. The fluid line as claimed in claim 6, wherein the wave-free wall portion in the circumferential direction covers an angle in the range between 0° and 180°.

10. The fluid line as claimed in claim 1, wherein the fluid line has at least one wave-free line portion which extends along the longitudinal axis away from the wave form portion.

11. The fluid line as claimed in claim 1, wherein the wave form portion has a plurality of wave crest elements, wherein in each case a wave trough element is arranged between in each case two wave crest elements, which wave trough element is arranged at the minimum distance to the longitudinal axis.

12. The fluid line as claimed in claim 11, wherein the fluid line has a curve in which the wave form portion is arranged.

13. The fluid line as claimed in claim 12, wherein the wave crest element is arranged on an outer radius of the curve.

14. The fluid line as claimed in claim 12, wherein the wave form portion has the minimum distance on an inner radius of the curve across its entire extent along the longitudinal axis.

15. The fluid line as claimed in claim 1, wherein the distance in the circumferential direction changes according to a square of a sine function.

16. The fluid line as claimed in claim 6, wherein the wave-free wall portion in the circumferential direction covers an angle in the range between 0° and 120°.

17. The fluid line as claimed in claim 6, wherein the wave-free wall portion in the circumferential direction covers an angle in the range between 0° and 80°.
